(19) United States
(12) Patent Application Publication
(10) Pub. No.: US 2014/0240365 A1
(43) Pub. Date: Aug. 28, 2014

(54) SEMICONDUCTOR DEVICE CONTROLLING SOURCE DRIVER AND DISPLAY DEVICE INCLUDING THE SEMICONDUCTOR DEVICE THE SAME

(71) Applicant: SAMSUNG ELECTRONICS CO., LTD., Suwon-si (KR)

(72) Inventors: Jin-Ho KIM, Suwon-si (KR); Tae-jin KIM, Seoul (KR); Woon-Taek OH, Seongnam-si (KR); Jae-Youl LEE, Hwaseong-si (KR); Young-Hwan CHANG, Seoul (KR)

(73) Assignee: Samsung Electronics Co., Ltd., Suwon-si (KR)

(21) Appl. No.: 13/836,355

(22) Filed: Mar. 15, 2013

(30) Foreign Application Priority Data
Feb. 25, 2013 (KR) 10-2013-0019994

(51) Int. Cl. G09G 5/00; G09G 5/02

(52) U.S. Cl. CPC G09G 5/005; G09G 5/02; G09G 5/008
USPC 345/690; 345/204; 345/213

(57) ABSTRACT

A semiconductor device includes: a transmitter transforming n data into first serial data and transmitting the first serial data through a first transmission line and transforming m data into second serial data and transmitting the second serial data through a second transmission line, where n and m are natural numbers at least one of which is greater than 1; a first driver integrated circuit (IC) group including n driver ICs; and a second driver IC group including m driver ICs, wherein each of the n driver ICs receives the first serial data through the first transmission line and is driven by part of the first serial data, each of the m driver ICs receives the second serial data through the second transmission line and is driven by part of the second serial data, and each of the n data and the m data includes identification information about a driver IC.

### CROSS-REFERENCE TO RELATED PATENT APPLICATION

This application claims priority from Korean Patent Application No. 10-2013-0019994 filed on Feb. 25, 2013 in the Korean Intellectual Property Office, the disclosure of which is incorporated herein by reference in its entirety.

### BACKGROUND

1. Field

Apparatuses and methods consistent with exemplary embodiments relate to a semiconductor device which controls source drivers and a display device including the semiconductor device.

2. Description of the Related Art

In a semiconductor device which drives a load terminal by driving driver integrated circuits (ICs), an increase in the number of driver ICs leads to an increase in the current consumption of a transmitting terminal which outputs signals for driving the driver ICs. The increased current consumption can result in increased power consumption of the semiconductor device, thereby reducing a driving efficiency of the semiconductor device.

### SUMMARY

One or more exemplary embodiments provide a semiconductor device which can reduce current consumption of a transmitting terminal.

One or more exemplary embodiments also provide a display device having increased driving efficiency by employing the semiconductor device.

However, the inventive concept is not restricted to the exemplary embodiments set forth herein. Various aspects of the inventive concept will become apparent to one of ordinary skill in the art to which the exemplary embodiments pertain by referencing the detailed description given below.

According to an aspect of an exemplary embodiment, there is provided a semiconductor device including: a transmitter transforming n data into first serial data and transmitting the first serial data through a first transmission line and transforming m data into second serial data and transmitting the second serial data through a second transmission line separate from the first transmission line, where n and m are natural numbers at least one of which is greater than 1; a first driver integrated circuit (IC) group including n driver ICs; and a second driver IC group including m driver ICs, wherein each of the n driver ICs receives the first serial data through the first transmission line and is driven by part of the first serial data, each of the m driver ICs receives the second serial data through the second transmission line and is driven by part of the second serial data, and each of the n data and the m data includes identification information about a driver IC.

According to an aspect of another exemplary embodiment, there is provided a display device including: a timing controller creating m serial data by grouping together every n image data, each including identification information and driving data, and outputting the m serial data through m transmission lines, where n and m are natural numbers at least one of which is greater than 1; and m source driver groups, each receiving any one of the m serial data through any one of the m transmission lines and including n source drivers, wherein each of the n source drivers is driven by the driving data included in image data, which has the identification information that matches identification information stored in the source driver, from among the n image data.

According to an aspect of an exemplary embodiment, there is provided a semiconductor device including: a transmitter which transmits at least one serial data each of which comprises a plurality of data through a transmission line; and at least one driver circuit which receives each of the at least one serial data and comprises a plurality of drivers each of which is configured to receive respective data of the plurality of data, wherein the driver circuit is configured to add at least one additional driver which is connected to the transmission line in parallel with the drivers or via one of the drivers.

### BRIEF DESCRIPTION OF THE DRAWINGS

The above and other aspects and features of the inventive concept will become more apparent by describing in detail exemplary embodiments thereof with reference to the attached drawings, in which:

FIG. 1 is a block diagram illustrating a connection relationship in a semiconductor device according to an exemplary embodiment;

FIG. 2 is a detailed block diagram of the semiconductor device shown in FIG. 1, according to an exemplary embodiment;

FIG. 3 is a detailed block diagram of a first clock generator shown in FIG. 2, according to an exemplary embodiment;

FIG. 4 is a detailed block diagram of a second clock generator shown in FIG. 2, according to an exemplary embodiment;

FIG. 5 is a diagram illustrating a method of driving the semiconductor device shown in FIG. 1, according to an exemplary embodiment;

FIG. 6 is a diagram illustrating the configuration of data shown in FIG. 5, according to an exemplary embodiment;

FIG. 7 is a diagram illustrating the wiring connection of the semiconductor device shown in FIG. 1, according to an exemplary embodiment;

FIG. 8 is a block diagram illustrating a connection relationship in a semiconductor device according to another exemplary embodiment;

FIG. 9 is a detailed block diagram of the semiconductor device shown in FIG. 8, according to an exemplary embodiment;

FIG. 10 is a block diagram illustrating a connection relationship in a semiconductor device according to another exemplary embodiment;

FIG. 11 is a block diagram illustrating a connection relationship in a semiconductor device according to another exemplary embodiment;

FIG. 12 is a diagram illustrating a method of driving the semiconductor device shown in FIG. 11, according to an exemplary embodiment;

FIG. 13 is a block diagram of a display device according to an exemplary embodiment;

FIG. 14 is a diagram illustrating an example of a semiconductor device which can be employed in the display device of FIG. 13, according to an exemplary embodiment;

FIG. 15 is a diagram illustrating another example of a semiconductor device which can be employed in the display device of FIG. 13, according to an exemplary embodiment;

FIG. 16 is a diagram illustrating another example of a semiconductor device which can be employed in the display device of FIG. 13, according to an exemplary embodiment; and

FIG. 17 is a diagram illustrating the configuration of image data output from a timing controller shown in FIG. 13, according to an exemplary embodiment.

### DETAILED DESCRIPTION OF THE EXEMPLARY EMBODIMENTS

Advantages and features of the present inventive concept and methods of accomplishing the same may be understood more readily by reference to the following detailed description of exemplary embodiments and the accompanying drawings. The inventive concept may, however, be embodied in many different forms and should not be construed as being limited to the embodiments set forth herein. Rather, these embodiments are provided so that this disclosure will be thorough and complete and will fully convey the inventive concept to those skilled in the art, and the inventive concept will only be defined by the appended claims. In the drawings, the thickness of layers and regions are exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the embodiments.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries may not be overly interpreted.

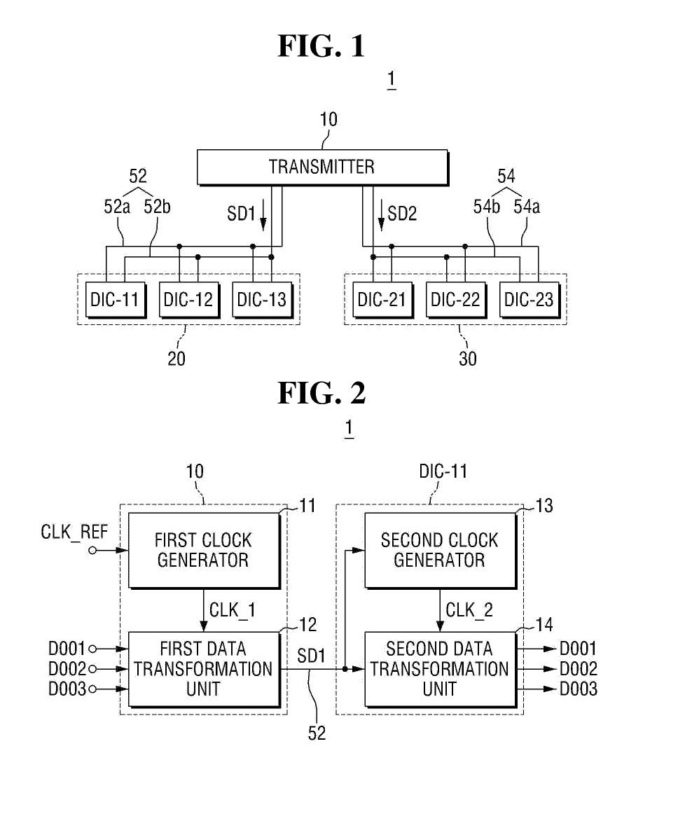

A semiconductor device according to an exemplary embodiment will now be described with reference to FIGS. 1 through 4.

FIG. 1 is a block diagram illustrating a connection relationship in a semiconductor device 1 according to an exemplary embodiment.

Referring to FIG. 1, the semiconductor device 1 includes a transmitter 10, a first driver integrated circuit (IC) group 20, and a second driver IC group 30.

The term ‘unit’ or ‘module’, as used herein, means, but is not limited to, a software or hardware component, such as a Field Programmable Gate Array (FPGA) or Application Specific Integrated Circuit (ASIC), which performs certain tasks. A unit or module may advantageously be configured to reside on the addressable storage medium and configured to execute on one or more processors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units or modules may be combined into fewer components and units or modules or further separated into additional components and units or modules.

The transmitter 10 transforms n (n is a natural number) data into first serial data SD1 and transmits the first serial data SD1 through a first transmission line 52. In addition, the transmitter 10 transforms m (m is a natural number) data into second serial data SD2 and transmits the second serial data SD2 through a second transmission line 54 separate from the first transmission line 52.

The first driver IC group 20 may include n driver ICs DIC-11 through DIC-13. In FIG. 1, a case where the first driver IC group 20 includes three driver ICs DIC-11 through DIC-13 (that is, n=3) is illustrated as an example. However, the inventive concept is not limited to this example. The number of driver ICs included in the first driver IC group 20 can be varied as desired. The driver ICs DIC-11 through DIC-13 included in the first driver IC group 20 may be connected in parallel to the first transmission line 52, as shown in FIG. 1.

Each of the driver ICs DIC-11 through DIC-13 included in the first driver IC group 20 may receive the first serial data SD1 through the first transmission line 52, and may be driven by part of the first serial data SD1. Specifically, each of the driver ICs DIC-11 through DIC-13 included in the first driver IC group 20 may be driven by data, which includes identification information that matches identification information stored in the driver IC, from among the first serial data SD1 received. This will be described in more detail later.

The second driver IC group 30 may include m driver ICs DIC-21 through DIC-23. In FIG. 1, a case where the second driver IC group 30 includes three driver ICs DIC-21 through DIC-23 (that is, m=3) is illustrated as an example. However, the inventive concept is not limited to this example. The number of driver ICs included in the second driver IC group 30 can be varied as desired. The driver ICs DIC-21 through DIC-23 included in the second driver IC group 30 may be connected in parallel to the second transmission line 54, as shown in FIG. 1.

Each of the driver ICs DIC-21 through DIC-23 included in the second driver IC group 30 may receive the second serial data SD2 through the second transmission line 54 and may be driven by part of the second serial data SD2. Specifically, each of the driver ICs DIC-21 through DIC-23 included in the second driver IC group 30 may be driven by data, which includes identification information that matches identification information stored in the driver IC, from among the second serial data SD2 received. This will be described in more detail later

In FIG. 1, the first transmission line 52 and the second transmission line 54 may include first sub lines 52a and 54a and second sub lines 52b and 54b, respectively. Specifically, the first transmission line 52 may include the first sub line 52a and the second sub line 52b, and the second transmission line 54 may include the first sub line 54a and the second sub line 54b.

In the current embodiment, each of the first and second serial data SD1 and SD2 may be a differential signal that uses the configuration of the first transmission line 52 and the second transmission line 54. In other words, the first serial data SD1 may be provided from the transmitter 10 to the first driver IC group 20 using a difference between a signal transmitted through the first sub line 52a and a signal transmitted through the second sub line 52b, and the second serial data SD2 may be provided from the transmitter 10 to the second driver IC group 30 using a difference between a signal transmitted through the first sub line 54a and a signal transmitted through the second sub line 54b.

The configuration of the semiconductor device 1 according to the current embodiment will now be described in more detail with reference to FIGS. 2 through 4.

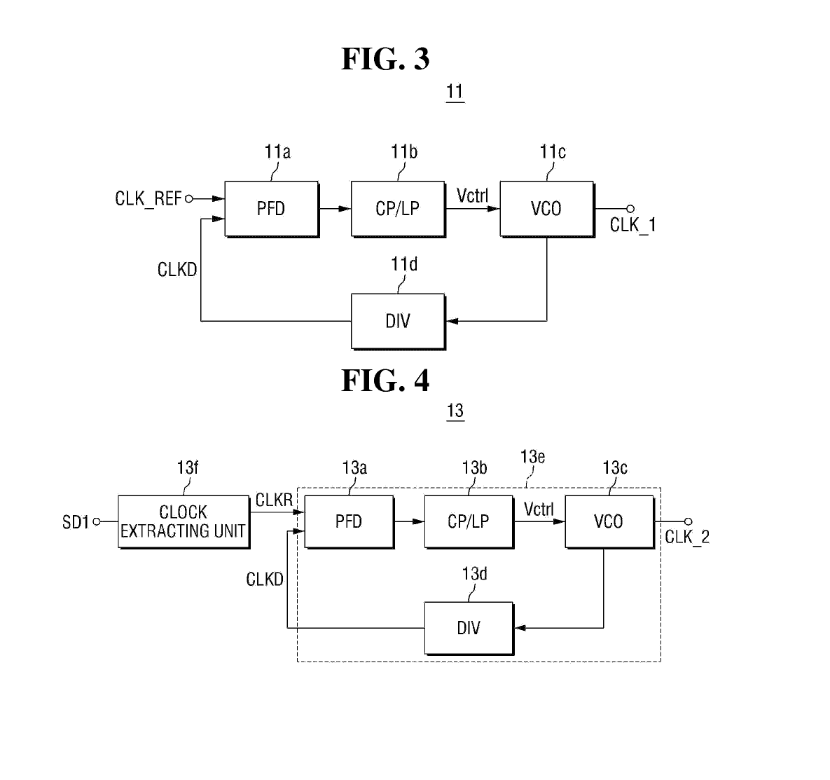

FIG. 2 is a detailed block diagram of the semiconductor device 1 shown in FIG. 1, according to an exemplary embodiment. FIG. 3 is a detailed block diagram of a first clock generator 11 shown in FIG. 2, according to an exemplary embodiment. FIG. 4 is a detailed block diagram of a second clock generator 13 shown in FIG. 2, according to an exemplary embodiment.

Referring to FIG. 2, the transmitter 10 may transform n data D001 through D003 into the first serial data SD1 using a reference clock signal CLK_REF and transmit the first serial data SD1 to the first driver IC DIC-11 included in the first driver IC group 20. While only the first driver IC DIC-11 included in the first driver IC group 20 is illustrated in FIG. 2 for the sake of simplicity, a description of the first driver IC DIC-11 may also be applied to other driver ICs DIC-12 and IDC-13 included in the first driver IC group 20 and the driver ICs DIC-21 through DIC-23 included in the second driver IC group 30.

The transmitter 10 may include the first clock generator 11 and a first data transformation unit 12. The reference clock signal CLK_REF and the n data D001 through D003 may be signals output according to the operation of a logic (not shown).

The first clock generator 11 may generate and output a first clock signal CLK_1 using the reference clock signal CLK_REF. The first clock generator 11 may include a phase locked loop (PLL) or a delay locked loop (DLL). The configuration of the first clock generator 11 will be described in more detail later.

The first data transformation unit 12 may transform the n data D001 through D003 into the first serial data SD1 using the first clock signal CLK_1. Here, the first serial data SD1 may include clock information used to separate the n data D001 through D003 from each other.

In some embodiments, the first data transformation unit 12 may consist of, e.g., a plurality of flip-flops (not shown). When the n data D001 through D003 are input in parallel to the first data transformation unit 12, each of the flip-flops (not shown) may transform the n data D001 through D003 into the first serial data SD1 by sequentially delaying the n data D001 through D003 in response to a corresponding clock signal from among the first clock signal CLK_1. However, the inventive concept is not limited to this example, and the configuration of the first data transformation unit 12 can be modified as desired.

In some embodiments, the first data transformation unit 12 may add dummy data if necessary in the process of transforming the n data D001 through D003 into the first serial data SD1. This will be described in more detail later.

The first driver IC DIC-11 may generate a second clock signal CLK_2 using the first serial data SD1 received from the transmitter 10 and transform the received first serial data SD1 into the n data D001 through D003 in response to the generated second clock signal CLK_2. The first driver IC DIC-11 may include the second clock generator 13 and a second data transformation unit 14.

The second clock generator 13 may generate the second clock signal CLK_2 using the received first serial data SD1. The first serial data SD1 transmitted from the first driver IC DIC-11 includes not only information about the n data D001 through D003 but also clock information needed to separate the n data D001 through D003 from one another. Therefore, the second clock generator 13 can generate the second clock signal CLK_2 by extracting the clock information from the received first serial data SD1.

The second clock generator 13 may include a PLL or a DLL. The configuration of the second clock generator 12 will be described in more detail later.

The second data transformation unit 14 may transform the first serial data SD1 into the n data D001 through D003 in response to the second clock signal CLK_2.

In some embodiments, the second data transformation unit 14 may consist of, e.g., a plurality of flip-flops (not shown). When the first serial data SD1 output from the first data transformation unit 12 is input to the second data transformation unit 14, each of the flip-flops (not shown) may extract the n data D001 through D003 sequentially by delaying the first serial data SD1 in response to a corresponding clock signal from among the second clock signal CLK_2. However, the inventive concept is not limited to this example, and the configuration of the second data transformation unit 14 can be modified as desired.

The detailed configuration of the first clock generator 11 will now be described in more detail with reference to FIG. 3.

Referring to FIG. 3, the first clock generator 11 may include a phase frequency detector (PFD) 11a, a charge pump/loop filter (CP/LP) 11b, a voltage controlled oscillator 11c (VCO), and a divider (DIV) 11d.

The PFD 11a may detect a phase difference between the reference clock signal CLK_REF and a divided clock signal CLKD by comparing the reference clock signal CLK_REF and the divided clock signal CLKD and output the phase difference. The CP/LP 11b may transform an output signal of the PFD 11a into a voltage signal and output the voltage signal as a control voltage signal Vctrl for controlling the VCO 11c. The VCO 11c may output the first clock signal CLK_1 having a predetermined frequency in response to the control voltage signal Vctrl. The DIV 11d may divide the first clock signal CLK_1 and output the divided first clock signal CLK_1 as the divided clock signal CLKD.

While a case where the first clock generator 11 is a PLL has been described above, the configuration of the first clock generator 11 is not limited to the configuration shown in FIG. 3. That is, as long as the first clock generator 11 can generate the first clock signal CLK_1 needed for a normal operation of the first data transformation unit 12, the configuration of the first clock generator 11 can be modified as desired. In some other embodiments, the first clock generator 11 can also be configured as a DLL.

The detailed configuration of the second clock generator 13 will now be described in more detail with reference to FIG. 4.

The second clock generator 13 may include a clock extracting unit 13f and a PLL 13e.

The clock extracting unit 13f may extract a clock signal CLKR from the received first serial data SD1. As described above, the first serial data SD1 includes the clock information needed to separate the n data D001 through D003 from one another. Therefore, the clock extracting unit 13f can extract the clock signal CLKR based on the clock information.

Similarly to the first clock generator 11 of FIG. 3, the PLL 13e may include a PFD 13a, a CP/LP 13b, a VCO 13, and a DIV 13d.

The PLL 13a may detect a phase difference between the clock signal CLKR and a divided clock signal CLKD by comparing the clock signal CLKR and the divided clock signal CLKD and output the phase difference. The CP/LP 13b may transform an output signal of the PFD 13a into a voltage signal and output the voltage signal as a control voltage signal Vctrl for controlling the VCO 13c. The VCO 13c may output the second clock signal CLK_2 having a predetermined frequency in response to the control voltage signal Vctrl. The DIV 13d may divide the second clock signal CLK_2 and output the divided second clock signal CLK_2 as the divided clock signal CLKD.

While a case where the second clock generator 13 is a PLL has been described above, the configuration of the second clock generator 13 is not limited to the configuration shown in FIG. 4. That is, as long as the second clock generator 13 can generate the second clock signal CLK_2 needed for normal operation of the second data transformation unit 14, the configuration of the second clock generator 13 can be modified as desired. In some other embodiments, the second clock generator 13 can also be configured as a DLL

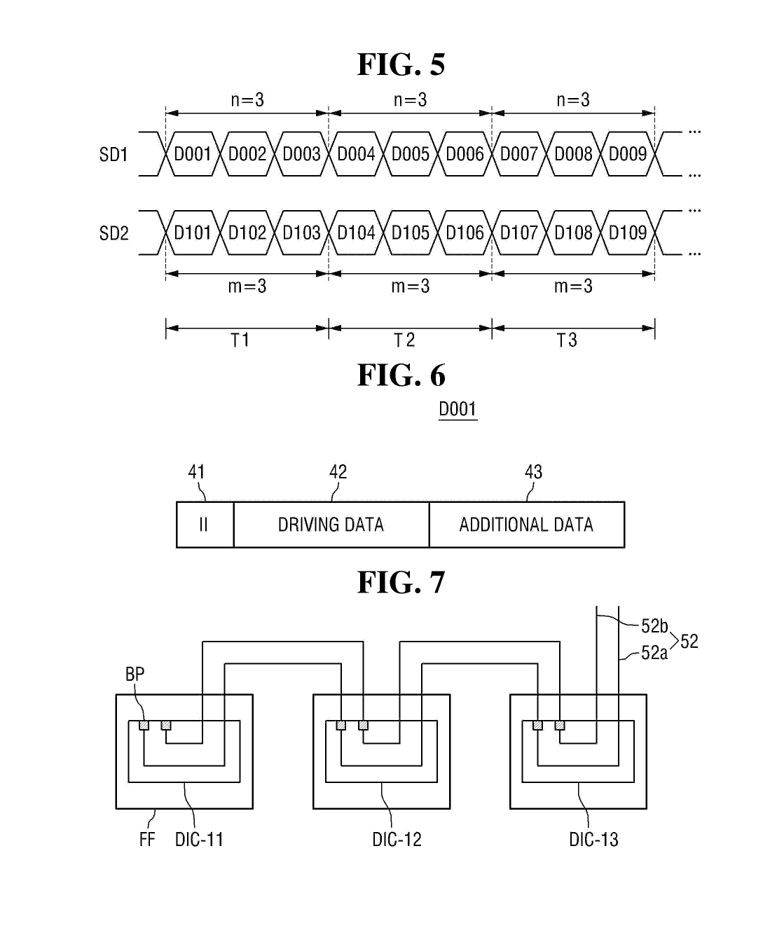

A method of driving a semiconductor device according to an exemplary embodiment will now be described with reference to both FIGS. 5 and 6.

FIG. 5 is a diagram illustrating a method of driving the semiconductor device 1 shown in FIG. 1, according to an exemplary embodiment. FIG. 6 is a diagram illustrating the configuration of data shown in FIG. 5, according to an exemplary embodiment.

Referring to FIG. 5, in a first period T1, the first data transformation unit 12 of the transmitter 10 may transform three (n=3) data D001 through D003 into the first serial data SD1 and transmit the first serial data SD1 through the first transmission line 52 and transform three (m=3) data D101 through D103 into the second serial data SD2 and transmit the second serial data SD2 through the second transmission line 54.

Each of the data D001 through D003 and D101 through D103 may include identification information (II) 41 of a driver IC, driving data 42 for the driver IC, and additional data 43 for keeping the driver IC driven by the driving data 42 during a predetermined period.

Each of the driver ICs DIC-11 through DIC-13 and DIC-21 through DIC-23 included in the first and second driver IC groups 20 and 30 may receive the first serial data SD1 or the second serial data SD2 through the first transmission line 52 or the second transmission line 54, generate the second clock signal CLK_2 from the first serial data SD1 or the second serial data SD2 by using the second clock generator 13, and extract three data D001 through D003 or D101 through D103 from the first serial data SD1 or the second serial data SD2 in response to the second clock signal CLK_2 by using the second data transformation unit 14.

Then, each of the driver ICs DIC-11 through DIC-13 and DIC-21 through DIC-23 may check and compare the identification information 41 of each of the extracted data D001 through D003 or D101 through D103 with identification information stored therein and be driven by the driving data 42 included in data which includes identification information 41 that matches the identification information stored in the driver IC.

For example, the identification information 41 included in the data D001 may indicate the first driver IC DIC-11, the identification information 41 included in the data D002 may indicate the second driver IC DIC-12, and the identification information 41 included in the data D003 may indicate the third driver IC DIC-13. In this case, the first driver IC DIC-11 may be driven by the driving data 42 included in the data D001, the second driver IC DIC-12 may be driven by the driving data 42 included in the data D002, and the third driver IC DIC-13 may be driven by the driving data 42 included in the data D003, respectively.

As described above, all of the three driver ICs DIC-11 through DIC-13 included in the first driver IC group 20 may receive the first serial data SD1, and all of the three driver ICs DIC-21 through DIC-23 included in the second driver IC group SD2 may receive the second serial data SD2. However, each of the driver ICs DIC-11 through DIC-13 and DIC-21 through DIC-23 may be driven by part of the first serial data SD1 or the second serial data SD2.

In a second period T2, the first data transformation unit 12 of the transmitter may transform three (n=3) data D004 through D006 into the first serial data SD1 and transmit the first serial data SD1 through the first transmission line 52 and transform three (m=3) data D104 through D106 into the second serial data SD2 and transmit the second serial data SD2 through the second transmission line 54.

Then, each of the driver ICs DIC-11 through DIC-13 and DIC-21 through DIC-23 included in the first and second driver IC groups 20 and 30 may receive the first or second serial data SD1 or SD2 through the first or second transmission lines 52 or 54 and may be driven by part of the first serial data SD1 or the second serial data SD2 in the same way as described above.

In the semiconductor device 1 according to the current embodiment, an increase in the number of driver ICs does not lead to a sharp increase in the number of transmission lines. That is, even if the number of driver ICs increases, the number of transmission ports can be maintained constant. Thus, according to an exemplary embodiment, the first driver IC group 20 or the second driver IC group 30 may be configured such that additional driver ICs can be added by being connected to the first transmission line 52 or the second transmission line 54, respectively, without adding additional transmission ports to the transmitter 10. Therefore, device manufacturing costs can be saved.

In addition, in the semiconductor device 1 according to the current embodiment, the driver ICs DIC-11 through DIC-13 and DIC-21 through DIC-23 are divided into driver IC groups, and the same serial data SD1 or SD2 is transmitted to each of the driver IC groups. Therefore, the current consumption of the transmitter 10 can be reduced, compared with a case where the transmitter 10 has to transmit a number of data equal to the number of driver ICs DIC-11 through DIC-13 and DIC-21 through DIC-23.

If each of the driver ICs DIC-11 through DIC-13 and DIC-21 through DIC-23 included in the semiconductor device 1 according to the current embodiment is connected in parallel to the first or second transmission line 52 or 54 as shown in FIG. 1, the amount of reflection noise may depend on a length of a stub branching from each of the first and second transmission lines 52 and 54. Wiring connection for reducing reflection noise in the semiconductor device 1 according to the current embodiment will now be described with reference to FIG. 7.

FIG. 7 is a diagram illustrating the wiring connection of the semiconductor device 1 shown in FIG. 1, according to an exemplary embodiment.

Referring to FIG. 7, each of the driver ICs DIC-11 through DIC-13 included in the first driver IC group 20 may be attached to and placed on, e.g., a flexible film FF. As shown in the drawing, the first transmission line 52 may be connected to bumps BP of each of the driver ICs DIC-11 through DIC-13 while having a minimum stub. That is, since a line branching from the first transmission line 52 (i.e., a main line) to connect the first transmission line 52 to each of the driver ICs DIC-11 through DIC-13 hardly exists, the stub can be minimized. This reduces the probability of impedance mismatch, thereby minimizing reflection noise.

Each of the driver ICs DIC-11 through DIC-13 may have a via receiver for receiving the first serial data SD1 but may not have a via transmitter for transmitting the first serial data SD1 to another driver IC DIC-11, DIC-12 or DIC-13. This will be described later.

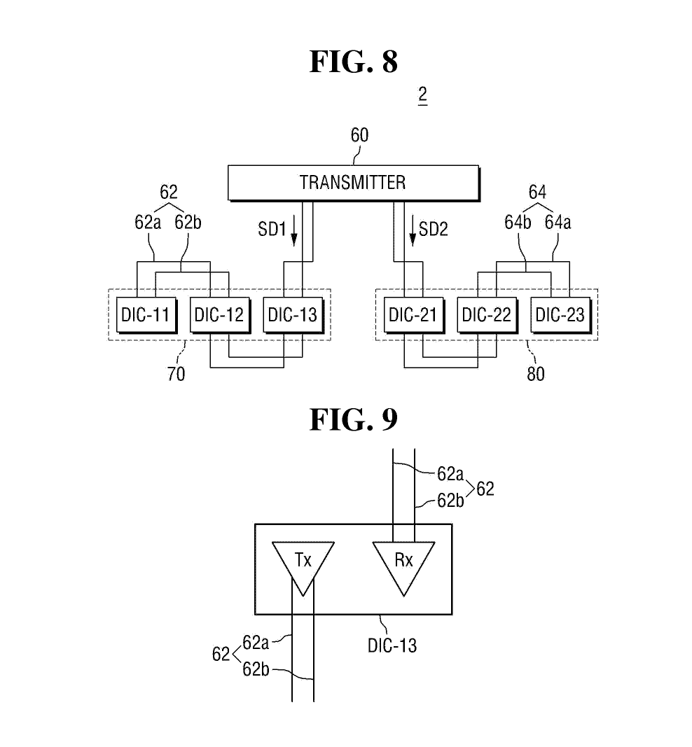

A semiconductor device according to another exemplary embodiment will now be described with reference to FIGS. 8 and 9.

FIG. 8 is a block diagram illustrating a connection relationship in a semiconductor device 2 according to another exemplary embodiment. FIG. 9 is a detailed block diagram of the semiconductor device 2 shown in FIG. 8, according to an exemplary embodiment. The current embodiment will hereinafter be described, focusing mainly on differences with the pervious embodiment.

Referring to FIG. 8, the semiconductor device 2 includes a transmitter 60, a first driver IC group 70, and a second driver IC group 80.

As in the previous embodiment, the first driver IC group 70 may include three (n=3) driver ICs DIC-11 through DIC-13. However, in the current embodiment, the driver ICs DIC-11 through DIC-13 included in the first driver IC group 70 may be connected in series to a first transmission line 62, as shown in FIG. 8.

As in the previous embodiment, the second driver IC group 80 may also include three (m=3) driver ICs DIC-21 through DIC-23. However, the driver ICs DIC-21 through DIC-23 included in the second driver IC group 80 may be connected in series to a second transmission line 64, as shown in FIG. 8.

Referring to FIG. 9, each of the driver ICs DIC-11 through DIC-13 and DIC-21 through DIC-23 connected in series to the first and second transmission lines 62 and 64 may include a via receiver Rx which receives first or second serial data SD1 or SD2 and a via transmitter Tx which transmits the first or second serial data SD1 or SD2 to another driver IC DIC-11, DIC-12, or DIC-13 or DIC-21, DIC-22 or DIC-23. That is, in the current embodiment, if the driver ICs DIC-11 through DIC-13 and DIC-21 through DIC-23 are connected in series to the first and second transmission lines 62 and 64, each of the driver ICs DIC-11 through DIC-13 and DIC-21 through DIC-23 may include the via receiver Rx and the via transmitter Tx.

In the semiconductor device 2 according to the current embodiment, an increase in the number of driver ICs does not lead to a sharp increase in the number of transmission lines. That is, even if the number of driver ICs increases, the number of transmission ports can be maintained constant. Therefore, as in the previous embodiment described above, the current consumption of the transmitter 60 can be reduced.

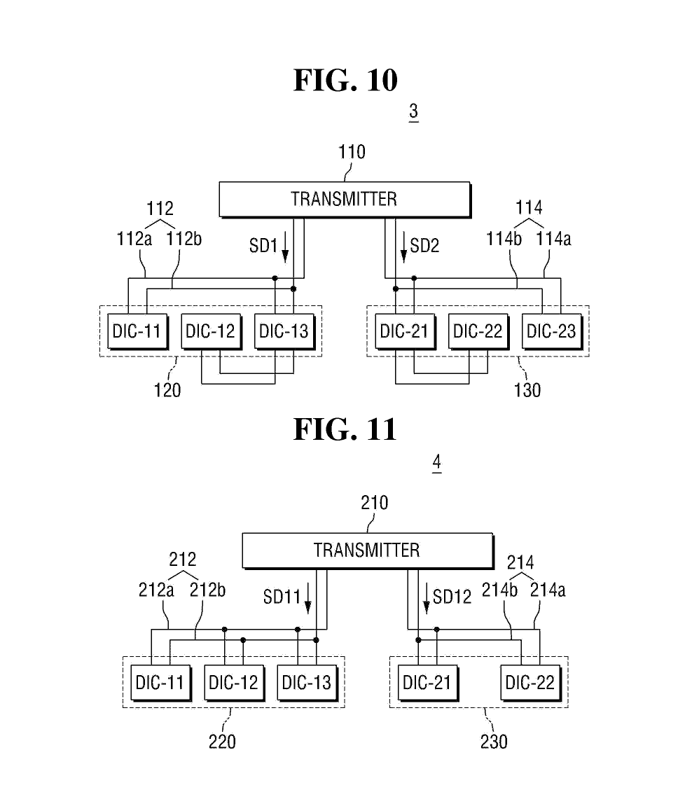

A semiconductor device according to another exemplary embodiment will now be described with reference to FIG. 10.

FIG. 10 is a block diagram illustrating a connection relationship in a semiconductor device 3 according to another exemplary embodiment. The current embodiment will hereinafter be described, focusing mainly on differences with the pervious embodiments.

Referring to FIG. 10, the semiconductor device 3 includes a transmitter 110, a first driver IC group 120, and a second driver IC group 130.

As in the previous embodiments, the first driver IC group 120 may include three (n=3) driver ICs DIC-11 through DIC-13. However, in the current embodiment, some of the driver ICs DIC-11 through DIC-13 included in the first driver IC group 120 may be connected in parallel to a first transmission line 112, and the other ones of the driver ICs DIC-11 through DIC-13 may be connected in series to the first transmission line 112 via one of the driver ICs DIC-11 through DIC-13 which is connected to the first transmission line 112 in parallel. Specifically, the first driver IC DIC-11 and the second and third driver ICs DIC-12 and DIC-13 may be connected to the first transmission line 112 in parallel to each other, whereas the second and third driver ICs DIC-12 and DIC-13 are connected to the first transmission line 112 in series to each other.

As in the previous embodiments, the second driver IC group 130 may also include three (m=3) driver ICs DIC-21 through DIC-23. However, in the current embodiment, some of the driver ICs DIC-21 through DIC-23 included in the second driver IC group 130 may be connected in parallel to a second transmission line 114, and the other ones of the driver ICs DIC-21 through DIC-23 may be connected in series to the second transmission line 114. Specifically, the sixth driver IC DIC-23 and the fourth and fifth driver ICs DIC-21 and DIC-22 may be connected to the second transmission line 114 in parallel to each other, whereas the fourth and fifth driver ICs DIC-21 and DIC-22 are connected to the second transmission line 114 in series to each other.

In the semiconductor device 3 according to the current embodiment, the current consumption of the transmitter 110 may also be reduced based on the same principle as described above. A repetitive description of the principle will be omitted.

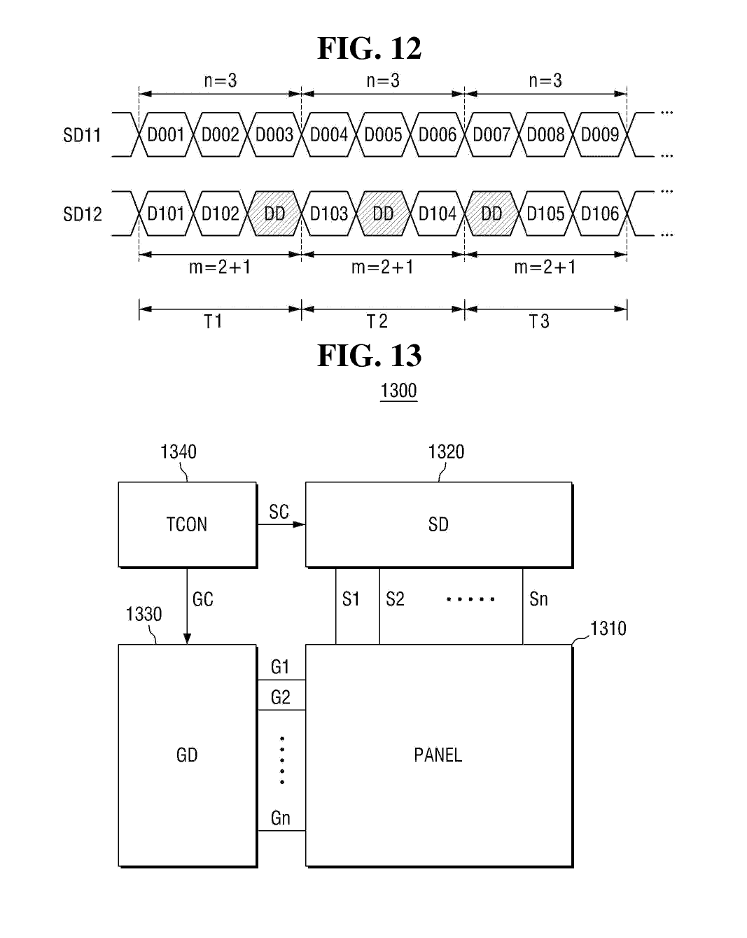

While a case where the number of driver ICs DIC-11 through DIC-13 included in the first driver IC group 20, 70 or 120 is equal to the number of driver ICs DIC-21 through DIC-23 included in the second driver IC group 30, 80 or 130 (that is, n=m) has been described above, the inventive concept is not limited to this case. In some embodiments, the number of driver ICs DIC-11 through DIC-13 included in the first driver IC group 20, 70 or 120 may be different from the number of driver ICs DIC-21 through DIC-23 included in the second driver IC group 30, 80 or 130. A semiconductor device according to another exemplary embodiment will now be described with reference to FIGS. 11 and 12.

FIG. 11 is a block diagram illustrating a connection relationship in a semiconductor device 4 according to another exemplary embodiment. FIG. 12 is a diagram illustrating a method of driving the semiconductor device 4 shown in FIG. 11, according to an exemplary embodiment. The current embodiment will hereinafter be described, focusing mainly on differences with the pervious embodiments.

Referring to FIG. 11, the semiconductor device 4 includes a transmitter 210, a first driver IC group 220, and a second driver IC group 230.

In the current embodiment, the number of driver ICs DIC-11 through DIC-13 included in the first driver IC group 220 is three (n=3). However, the number of driver ICs DIC-21 and DIC-22 included in the second driver IC group 230 is two (m=2). That is, the number of driver ICs DIC-11 through DIC-13 included in the first driver IC group 220 is different from the number of driver ICs DIC-21 and DIC-22 included in the second driver IC group 230.

In this case, referring to FIG. 12, a first data transformation unit 12 included in the transmitter 210 may add dummy data DD in the process of transforming second serial data SD12 which is to be transmitted through a second transmission line 214.

Specifically, the first data transformation unit 12 included in the transmitter 210 may transform first serial data SD11, which is to be transmitted through a first transmission line 212, in the same way as in the previous embodiments but may transform the second serial data SD12, which is to be transmitted through the second transmission line 124, by adding the dummy data DD.

The position to which the dummy data DD is added can be changed as desired. That is, the dummy data DD may be added at the end in a first period T1, may be added between data in a second period T2, and may be added at the beginning in a third period T3. Since identification information 41 of the dummy data DD does not indicate a driver IC, none of the driver ICs DIC-21 and DIC-22 is driven by the dummy data DD.

A display device employing the semiconductor devices 1 through 4 according to the above-described embodiments will now be described with reference to FIGS. 13 through 16.

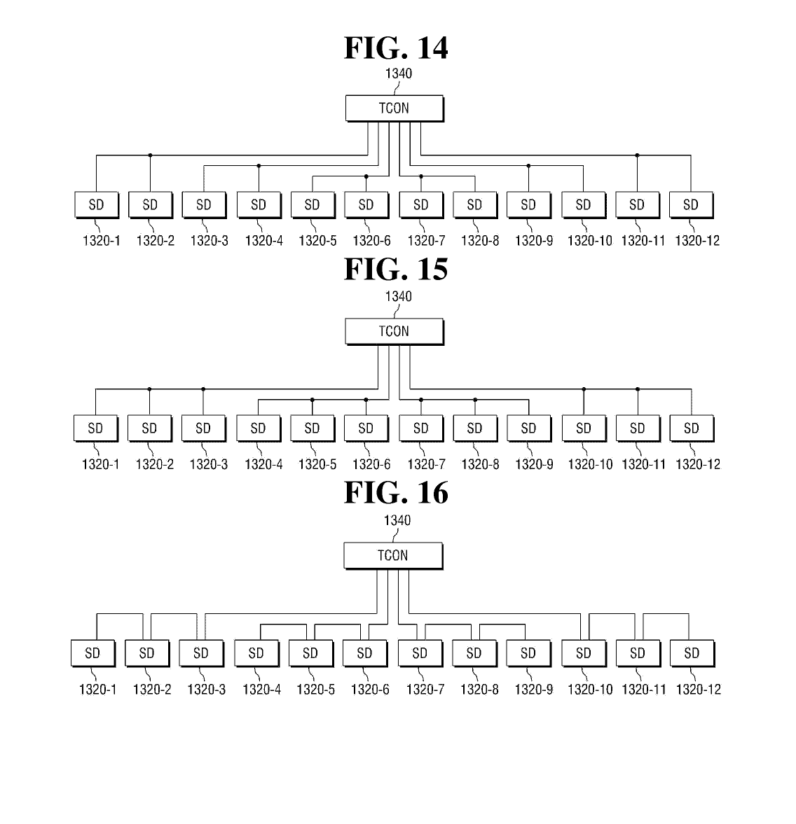

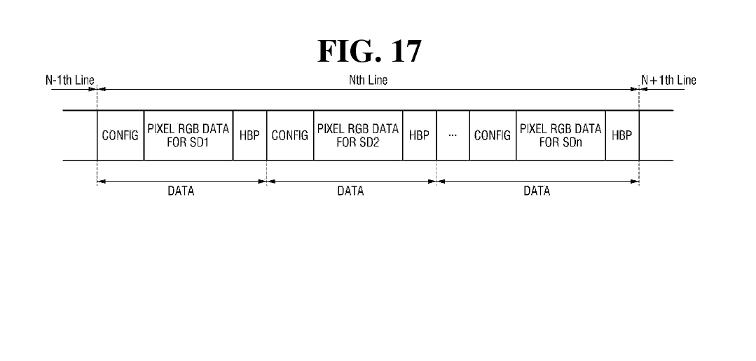

FIG. 13 is a block diagram of a display device 1300 according to an exemplary embodiment. FIG. 14 is a diagram illustrating an example of a semiconductor device which can be employed in the display device 1300 of FIG. 13, according to an exemplary embodiment. FIG. 15 is a diagram illustrating another example of a semiconductor device which can be employed in the display device 1300 of FIG. 13, according to an exemplary embodiment. FIG. 16 is a diagram illustrating another example of a semiconductor device which can be employed in the display device 1300 of FIG. 13, according to an exemplary embodiment. FIG. 17 is a diagram illustrating the configuration of image data output from a timing controller 1340 shown in FIG. 13, according to an exemplary embodiment.

Referring to FIG. 13, the display device 1300 may include a panel 1310, a source driver 1320, a gate driver 1330, and the timing controller 1340.

The panel 1310 may include a plurality of pixel regions. A plurality of gate lines G1 through Gn and a plurality of source lines S1 through Sn may intersect each other in a matrix form, and the intersections of the gate lines G1 through Gn and the source lines S1 through Sn may be defined as the pixel regions.

The timing controller 1340 may control the source driver 1320 and the gate driver 1330. The timing controller 1340 may receive a plurality of control signals and a plurality of data signals from an external system (not shown). The timing controller 1340 may generate a gate control signal GC and a source control signal SC in response to the received control signals and data signals and may output the gate control signal GC to the gate driver 1330 and the source control signal SC to the source driver 1320.

The gate driver 1330 may transmit a gate driving signal to the panel 1310 sequentially through the gate lines G1 through Gn in response to the gate control signal GC. In addition, whenever the gate lines G1 through Gn are selected sequentially, the source driver 1320 may transmit image data to the panel 1310 through the source lines S1 through Sn in response to the source control signal SC.

The timing controller 1340 and the source driver 1320 may be configured in a similar way to the configurations of the semiconductor devices 1 through 4 according to the above-described embodiments.

That is, in some embodiments, referring to FIG. 14, the timing controller 1340 may create six serial data by grouping every two image data together and output the six serial data through six transmission lines. Then, each source driver group including two source drivers (i.e., two of 1320-1 through 1320-12) may receive any one of the six serial data through any one of the six transmission lines. Each source driver included in each source driver group may be driven by any one of the two grouped image data.

In some other embodiments, referring to FIG. 15, the timing controller 1340 may create four serial data by grouping every three image data together and output the four serial data through four transmission lines. Then, each source driver group including three source drivers (i.e., three of 1320-1 through 1320-12) may receive any one of the four serial data through any one of the four transmission lines. Each source driver included in each source driver group may be driven by any one of the three grouped image data.

In some other embodiments, referring to FIG. 16, the timing controller 1340 may create four serial data by grouping every three image data together and output the four serial data through four transmission lines. Then, each source driver group including three source drivers (i.e., three of 1320-1 through 1320-12) which are connected in series to each other may receive any one of the four serial data through any one of the four transmission lines. Each of the serially connected three source drivers included in each source driver group may be driven by any one of the three grouped image data.

Image data output from the timing controller 1340 to the source driver 1320 may be configured as shown in FIG. 17. That is, one image data may include setting data CONFIG which includes identification information about the source driver 1320 and information about the operation of the display device 1300, RGB data of each pixel which is needed to drive the source driver 1320, and data about a horizontal back porch (HBP) which is needed to maintain the RGB data during a predetermined period. As shown in the drawings, each image data may be transformed into serial data by the timing controller 1340 and provided accordingly to the source driver 1320.

In concluding the detailed description, those skilled in the art will appreciate that many variations and modifications can be made to the above exemplary embodiments without substantially departing from the principles of the inventive concept. Therefore, the disclosed exemplary embodiments of the inventive concept are used in a generic and descriptive sense only and not for purposes of limitation.

What is claimed is:

1. A semiconductor device comprising:
a transmitter transforming n data into first serial data and transmitting the first serial data through a first transmission line and transforming m data into second serial data and transmitting the second serial data through a second transmission line separate from the first transmission line, where n and m are natural numbers at least one of which is greater than 1;
a first driver integrated circuit (IC) group comprising n driver ICs; and
a second driver IC group comprising m driver ICs,
wherein each of the n driver ICs receives the first serial data through the first transmission line and is driven by part of the first serial data,
wherein each of the m driver ICs receives the second serial data through the second transmission line and is driven by part of the second serial data, and
wherein each of the n data and the m data comprises identification information about a driver IC.

2. The semiconductor device of claim 1, wherein each driver IC is driven by data having the identification information which matches identification information stored in the driver IC.

3. The semiconductor device of claim 2, wherein n and m are equal natural numbers.

4. The semiconductor device of claim 1, wherein the n driver ICs are connected in parallel to the first transmission line, and the m driver ICs are connected in parallel to the second transmission line.

5. The semiconductor device of claim 1, wherein some of the n driver ICs are connected in series to each other and connected to the first transmission line, and the other ones of the n driver ICs are connected to the first transmission line in parallel with the driver ICs which are connected in series to each other and connected to the first transmission line.

6. The semiconductor device of claim 5, wherein each of the driver ICs connected in series to each other and connected to the first transmission line comprises a via receiver which receives the first serial data and a via transmitter which transmits the first serial data.

7. The semiconductor device of claim 1, wherein each of the n data and the m data further comprises driving data for the driver IC and additional data for maintaining the driver IC driven by the driving data during a predetermined period.

8. The semiconductor device of claim 7, wherein the driving data comprises red, green and blue (RGB) data of each pixel, and the additional data comprises data about a horizontal back porch (HBP).

9. The semiconductor device of claim 1, wherein the first transmission line is placed to penetrate through at least one of the n driver ICs in order to minimize a stub length, and the second transmission line is placed to penetrate through at least one of the m driver ICs in order to minimize the stub length.

10. The semiconductor device of claim 1, wherein each of the first and second transmission lines comprises a first sub line and a second sub line, and each of the first and second serial data is a differential signal.

11. The semiconductor device of claim 1, wherein n and m are different natural numbers.

12. The semiconductor device of claim 11, wherein any one of the first serial data and the second serial data comprises dummy data.

13. The semiconductor device of claim 1, wherein the first serial data comprises clock information needed to separate the n data from the first serial data.

14. The semiconductor device of claim 13, wherein the transmitter comprises:
a first clock generator generating a first clock signal using a reference clock signal: and
a first data transformation unit transforming the n data into the first serial data using the first clock signal, and
wherein each driver IC comprises:
a second clock generator generating a second clock signal from the first serial data using the clock information included in the first serial data: and
a second data transformation unit extracting the n data from the first serial data using the second clock signal.

15. A display device comprising:
a timing controller creating m serial data by grouping together every n image data, each comprising identification information and driving data, and outputting the m serial data through m transmission lines, where n and m are natural numbers at least one of which is greater than 1; and
m source driver groups, each receiving any one of the m serial data through any one of the m transmission lines and comprising n source drivers,
wherein each of the n source drivers is driven by the driving data included in image data, which has the identification information that matches identification information stored in the source driver, from among the n image data.

16. The display device of claim 15, wherein the n source drivers are connected to one of the m transmission lines in parallel.

17. The display device of claim 15, wherein at least two of the n source drivers are connected to one of the m transmission lines in parallel, and at least one of the n source drivers is connected to the one of the m transmission lines via one of the at least two source drivers.

18. A semiconductor device comprising:
a transmitter which transmits at least one serial data each of which comprises a plurality of data through a transmission line; and
at least one driver circuit which receives each of the at least one serial data and comprises a plurality of drivers each of which is configured to receive respective data of the plurality of data,
wherein the driver circuit is configured to add at least one additional driver which is connected to the transmission line in parallel with the drivers or via one of the drivers.

19. The semiconductor device of claim 18, wherein the additional driver is configured to receive, from the transmitter, data different from the plurality of data.

20. The semiconductor device of claim 18, wherein the at least one driver circuit comprises first and second driver circuits,
wherein a number of the drivers in the first driver circuit is greater than a number of the drivers in the second driver circuit, and
wherein the plurality of data received at the second driver circuit includes dummy data.
